(19) United States
(12) Patent Application Publication
(10) Pub. No.: US 2025/0183261 A1
(43) Pub. Date: Jun. 5, 2025

(54) CONTORTED MACROMOLECULAR LADDERS FOR FAST-CHARGING AND LONG-LIFE LITHIUM BATTERIES

(71) Applicant: THE TRUSTEES OF COLUMBIA UNIVERSITY IN THE CITY OF NEW YORK, New York, NY (US)

(72) Inventors: Colin NUCKOLLS, New York, NY (US); Zexin JIN, New York, NY (US); Qian CHENG, New York, NY (US); Yuan YANG, New York, NY (US); Si Tong BAO, New York, NY (US); Ruiwen ZHANG, New York, NY (US); Austin M. EVANS, Jersey City, NJ (US); Fay NG, New York, NY (US); Michael L. STEIGERWALD, Martinsville, NJ (US)

(21) Appl. No.: 18/840,633

(22) PCT Filed: Mar. 24, 2023
(86) PCT No.: PCT/US2023/016221

§ 371 Date: Aug. 22, 2024

Related U.S. Application Data
(60) Provisional application No. 63/323,753, filed on Mar. 25, 2022.

(51) Int. Cl. H01M 4/137; H01M 4/02; H01M 10/0525

(52) U.S. Cl. CPC H01M 4/137; H01M 10/0525; H01M 2004/028

(57) ABSTRACT

The disclosed matter provides a Contorted Macromolecular Ladders for Fast-charging and Long-Life Lithium Batteries, and the method thereof. By tuning the length of hPDI[n], the electrical and ionic conductivity of the resulting contorted macromolecular ladders can be modulated for improving the lithium-ion coordination and transport. The materials can be applied into organic battery electrode materials which are sustainable, fast-charging, and long lasting.

### CROSS-REFERENCE TO RELATED APPLICATION

This PCT application claims priority to U.S. Provisional Patent Application No. 63/323,753, which was filed on Mar. 25, 2022, the entire contents of which are incorporated by reference herein.

### STATEMENT OF GOVERNMENT INTEREST

This invention was made with government support under DMR-2002634 awarded by the National Science Foundation (NSF) and N00014-20-1-2477 awarded by the Office of Naval Research (ONR). The government has certain rights in the invention.

### BACKGROUND

The disclosed subject matter relates to the field of lithium-ion batteries and more specifically, to a molecular array of contorted macromolecular ladders as to organic battery electrode materials for fast-charging and long-life lithium-ion batteries.

Lithium-ion batteries (LIBs) are an energy storage system that have accelerated the development of today's information society. Certain LIBs can have relatively high performance, but power density and cycling stability degrade during the charge-discharge cycle. This can be particularly acute for many applications such as electrical vehicles due to their relatively long charging time and substantial capacity loss after hundreds of cycles.

In contrast with certain inorganic electrode materials, OBEMs can provide for concurrent high-power density and energy density, for example, due to their molecular turnability which can provide for high ionic diffusion coefficients and high specific capacities. OBEMs also have relatively low production costs, low environmental impact, and can be sustainable given the natural abundance of their components. However, OBEMs can also have a lowered specific capacity and relatively poor cycling stability as organic molecules can leach into the electrolyte solution during redox reactions. Organic polymers can be used in view of such deficiencies; however, they can have low charge capacity due to linkers and solubilizing side chains being non-redox reactive. Further, the relatively low intrinsic electrical conductivity of OBEMs can lower their ability to achieve high-rate capability and areal mass-loading, leading to incorporation of large amounts of conductive additives in order to achieve acceptable results.

There is thus a need to provide macromolecules and materials which can be used in lithium batteries to provide sustainable, fast-charging, and long-life lithium batteries.

### SUMMARY

The disclosed subject matter relates to organic battery electrode materials (OBEMs) and provides for methods and techniques for the preparation of macromolecules, such as contorted and fully conjugated macromolecules, and battery cathodes including the same. Such macromolecules can form fast-charging and long lifetime cathodes for incorporation into lithium batteries.

The disclosed subject matter addresses these and other needs by providing a molecular array design of contorted, fully conjugated ladder-type macromolecules. In certain embodiments, the macromolecule can be contorted at one or more aromatic sites. In certain embodiments, the macromolecule can be contorted at six aromatic sites. Atomically defined, ladder-type fully conjugated, and long macromolecular structures of the disclosed subject matter can be synthesized through a synthetic protocol. In certain embodiments, the macromolecule is configured to have at least a ladder-type conjugated structure with a plurality of hPDI[n] oligomers, where n is an integer from 1 to 6, e.g., hPDI[6].

The disclosed subject matter also provides methods including repetitive Suzuki reaction-Mallory photocyclization sequences that can provide a quantitative photocyclization in order to prepare, for example, helical perylene diimide[6](hPDI[6]-C₁₁) from shorter helical perylene diimide[2] (hPDI[2]-C₁₁). In certain embodiments, a method to synthesize a molecular array of contorted and conjugated macromolecular ladders is provided. In certain embodiments, the method includes preparing a precursor having a plurality of hPDI[n], where n is an integer from 1 to 6, polymerizing the precursor by repetitive Suzuki-Mallory polymerization process to form a contorted and conjugated macromolecular ladder having a ladder-type conjugated structure and comprising the hPDI[n].

In certain embodiments, the PDI subunit is fused by ethylene subunits.

In certain embodiments, the polymerization process includes modeling on conjugation length and contortion of the macromolecular ladders. Further, the method can include an increase of the length of π-conjugation and the number of contorted aromatic sites to adjust. In certain embodiments, the hPDI[n] is prepared from hPDI[n]-Cn.

In certain embodiments, the hPDI[n] is ribbon-structure conjugated and contorted.

The disclosed subject matter also provides an electrode for use in a lithium-ion battery, including a molecular of contorted, fully conjugated ladder-type macromolecules. In certain embodiments, the molecular is formed as a cathode.

The disclosed matter provides a lithium-ion battery, including an electrode using a molecular of contorted, fully conjugated ladder-type macromolecules.

The synthesis protocol of the disclosed subject matter can provide for the synthesis of longer ribbons by avoiding incomplete photocyclization (e.g., synthesis of hPDI[n], up to n=4). In certain embodiments, the alkyl chains can be quantitatively removed, for example, by vacuum thermolysis. Such processes for the removal of the alkyl chains can increase a gravimetrical capacity, for example, by reducing electro-inactive mass and can also render the material insoluble. In certain embodiments, the structure of the resulting macromolecule can be confirmed, for example, by ¹³C solid-state nuclear magnetic resonance (NMR), infrared spectroscopy, matrix assisted laser desorption/ionization (MALDI) mass spectroscopy, or combinations thereof. In certain embodiments, the macromolecule can be a contorted helical perylene diimide[6] (hPDI[6]) macromolecule. In such embodiments, six (6) redox-active PDI subunits can be fused together, for example, by ethylene subunits. Such macromolecules can exhibit high-rate capability and cycling stability.

In certain aspects, by adjusting the length of the hPDI[n] oligomers, the electrical and ionic conductivity of the material can be simultaneously modulated. The length of the ladders of the oligomer macromolecules can adjust the conjugation length, and the contortion can implement lithium-ion coordination and transport. Further, the electrical and ionic conductivity can be improved by the increase in the length of π-conjugation and the number of contorted aromatic sites. The electrical conductivity of macromolecules of the disclosed subject matter can be at least one order of magnitude higher than counterparts with shorter ribbons. In certain aspects, the electrical conductivity of the hPDI[n] family can increase as the ribbons are extended. The improvement in electrical conductivity can be due, for example, to the length of the conjugated structure of hPDI[n]. Thus, increasing the length of the conjugated ribbons, for example, such as a contorted helical perylene diimide[6](hPDI[6]) macromolecule, can improve electrical conductivity.

In certain embodiments, the macromolecule of the disclosed subject matter can be formulated as a cathode. Such formulated cathodes can provide a relatively high-rate performance which can reduce a charging time to less than about 1 minute, less than about 50 seconds, or less than about 40 seconds. In certain embodiments, batteries incorporating macromolecules of the disclosed subject matter can be charged to about 67% in about 35 seconds or less. Further, an output power density of the cathode can be up to about 22,000 W/kg or up to about 28,000 W/kg. In certain embodiments, the output power density can be at least about two orders of magnitude higher than standard lithium-ion batteries (LIBs). The cathodes of the disclosed subject matter incorporating the macromolecules disclosed herein can advantageously have high cycling stability, for example, in over 10,000 charge-discharge cycles with capacity fade of about 0.004% and about 0.002% per cycle for 7.7° C. and 77° C., respectively. Thus, the cathodes of the disclosed subject matter can have high cycling stability without appreciable capacity decay. Further, such cathodes can maintain their performance in high mass loading and high temperature conditions.

In certain aspects, when fabricated as the cathode in lithium-ion batteries, the macromolecules of the disclosed subject matter exhibit both high electrical conductivity and high ionic conductivity. Further, such materials can exhibit a power density of at least two orders of magnitude higher than certain conventional inorganic materials. In certain aspects, such materials can be charged in less than about 1 minute or within 35 seconds to at least about 67% of their maximum capacity. Additionally, the materials of the disclosed subject matter can have high cycling stability and can operate at least about 10,000 charge-discharging cycles without any appreciable capacity decay. The material including macromolecules of the disclosed subject matter can also be compatible with certain manufacturing techniques for commercial batteries without further modification, and provide techniques to prepare sustainable, fast-charging, and long lasting OBEMs, such as batteries.

### BRIEF DESCRIPTION OF THE DRAWINGS

The patent or application file contains at least one drawing executed in color, Copies of this patent or patent application publication with color drawing(s) will be provided by the Office upon request and payment of the necessary fee.

Reference will now be made in detail to the various exemplary embodiments of the disclosed subject matter, which are illustrated in the accompanying drawings. The accompanying drawings, where like reference numerals refer to identical or functionally similar elements throughout the separate views, serve to further illustrate various embodiments and to explain various principles and advantages all in accordance with the disclosed subject matter.

FIG. 1A provides a schematic structure of hPDI[6] in an embodiment of the disclosed subject matter. FIG. 1B provides a Rate-Capacity retention curve of hPDI[6] with other compared organic cathode materials in an embodiment of the disclosed subject matter.

FIG. 2A provide a scheme of the iterative protocol to synthesize hPDI[6] ribbon. FIG. 2B provides a thermogravimetric demonstration of hPDI[6]-C₁₁. FIG. 2C provides a solid state ¹³C NMR demonstration for hPDI[6] in an embodiment of the disclosed subject matter.

FIG. 3A-3F illustrate an electrochemical characterization of hPDI[n]. FIG. 3A provides illustrative molecular structures of the compounds with different length and modification: hPDI[3] (blue), hPDI[4] (green), hPDI[5] (orange), hPDI[6] (red), PDI (black) and PDIv (cyan). FIG. 3B provides an electrical conductivity and bandgap of hPDI[n]. FIGS. 3C and 3D provide an EIS and CV (scan rate: 1 mV/s) of cathode materials, respectively. FIG. 3E provides a cycling performance of hPDI[n] at 1 A/g; FIG. 3F provides a cycling performance of hPDI[6] at 7.7 C and 77 C, in an embodiment of the disclosed subject matter.

FIG. 4A-4B provide demonstrations of practical application of hPDI[6] in batteries. FIG. 4A provides a demonstration of high mass loading of hPDI[6] batteries with an areal mass loading of 5 mg/cm². FIG. 4B provides a demonstration of 60° C. high temperature test with the mass loading of 1 mg/cm². FIG. 4C provides an image of hPDI[6] batteries powering up an LED fan, in an embodiment of the disclosed subject matter.

It is to be understood that both the foregoing general description and the following detailed description are exemplary and are intended to provide further explanations of the disclosed subject matter.

### DETAILED DESCRIPTION

The disclosed subject matter provides a molecular array of contorted macromolecular ladders, preparation for same, and use in an electrode and lithium-ion battery. This molecular array can deliver a highly efficient performance when utilized in lithium-ion battery applications.

For clarity, but not by way of limitation, the detailed description of the disclosed subject matter is divided into the following subsections:
I. Definition
II. Molecular
III. Synthesis

### I. Definition

As used herein, the term “macromolecular ladder” refers to a class of large molecules that are typically composed of repeating units linked together in a linear or branched structure. These molecules can be composed of a variety of materials, including polymers, dendrimers, and other types of macromolecules. Regarding contorted macromolecular ladders, the repeating units can be composed of multiple aromatic rings connected by rigid linkers, which form a contorted 3D structure that resembles a ladder. The resulting structure can be highly ordered with a unique topology, leading to several advantageous properties, including high stability, high molecular weight, and fast ion transport, facilitating application thereof on Lithium-ion battery.

As used herein, the term “hPDI[n]” stands for helical perylene diimide [6] macromolecule, where several redox-active PDI subunits can be fused together by ethylene subunits. In the case of hPDI[n], the number “n” refers to the number of hPDI units that are connected in the polymer chain. For example, hPDI[2] would be a dimer composed of two hPDI units linked together, while hPDI[3] would be a trimer composed of three hPDI units linked together, and so on. The hPDI[n] compounds can have several advantageous properties that make them effective for use in the synthesis of contorted macromolecular ladders. Accordingly, “PDIv” stands for “PDI-vinyl conjugated polymer”.

As used herein, the term “OBEMs” stands for organic battery electrode materials, a type of material which can provide opportunities to achieve relatively high-power density without sacrificing energy density, due to their molecular tunability simultaneously providing high ionic diffusion coefficients and high specific capacities.

As used herein, the term “Suzuki reaction” refers to a well-known organic chemical reaction that involves the coupling of two organic compounds, typically an aryl halide with an organoboronic acid, to form a new carbon-carbon bond. As embodied in the exemplary disclosed matters, this reaction can be used to elongate the molecular chain of the helical perylene diimide molecule from hPDI[n, n<6] to hPDI[6].

As used herein, the term “Mallory photocyclization” refers to a photochemical reaction that involves the formation of a cyclic compound (e.g., a ring-shaped molecule) from an open-chain precursor molecule. As embodied in the exemplary disclosed matters, the Mallory photocyclization is typically used to form the helical structure of the perylene diimide molecule. This reaction can be repeated several times to form the final product comprising hPDI[n] molecule.

As used herein, the term “synthesis protocol” refers to a controlled, tunning, and quantitative synthesis, e.g., photocyclization, which designs a reaction proceeds to completion and the starting material is converted to the desired product. It can be important for ensuring that the final product is pure and of high quality.

As used herein, the term “pre-hPDI synthesis” refers to the production of a precursor form of PDI that has not yet undergone the post-translational modifications necessary to form the fully functional hPDI[n] isoform.

As used herein, the term “BMIDA-Bpin” stands for trans-2-(pinacol boronate) vinylboronic acid MIDA ester, a reactant during Suzuki reaction with Br-hPDI.

As used herein, “HOMO” stands for highest occupied molecular orbital and “LUMO” stands for lowest unoccupied molecular orbital, respectively. The energy difference between the HOMO and LUMO is termed the HOMO-LUMO gap, whose amplitude can be used to predict the strength and stability of the molecular complexes. Generally, the larger a compound's HOMO-LUMO gap, the more stable the compound.

As used herein, “Randles-Ševčik equation” refers to a mathematical equation used in electrochemistry to describe the effect of scan rate on the peak current for a cyclic voltammetry electrochemical measurement. It can be used to calculate the peak current using the scan rate in an observed voltammogram.

As used herein, “areal mass loading” refers to the mass of active material per unit area of an electrode. It can be used to evaluate the gravimetric energy density of the electrode. A higher mass loading can be preferable in an initial assessment as it can better utilize the areal components, e.g., carrier foils and separators.

### II. Molecular

### [Schematic Structure]

In certain embodiments of the disclosed matter, a contorted and fully conjugated macromolecule for a fast-charging and long lifetime cathode of lithium batteries is provided to resolve the relatively low intrinsic electrical conductivity of certain OBEMs and improve the ability thereof to achieve high-rate capability and areal mass-loading.

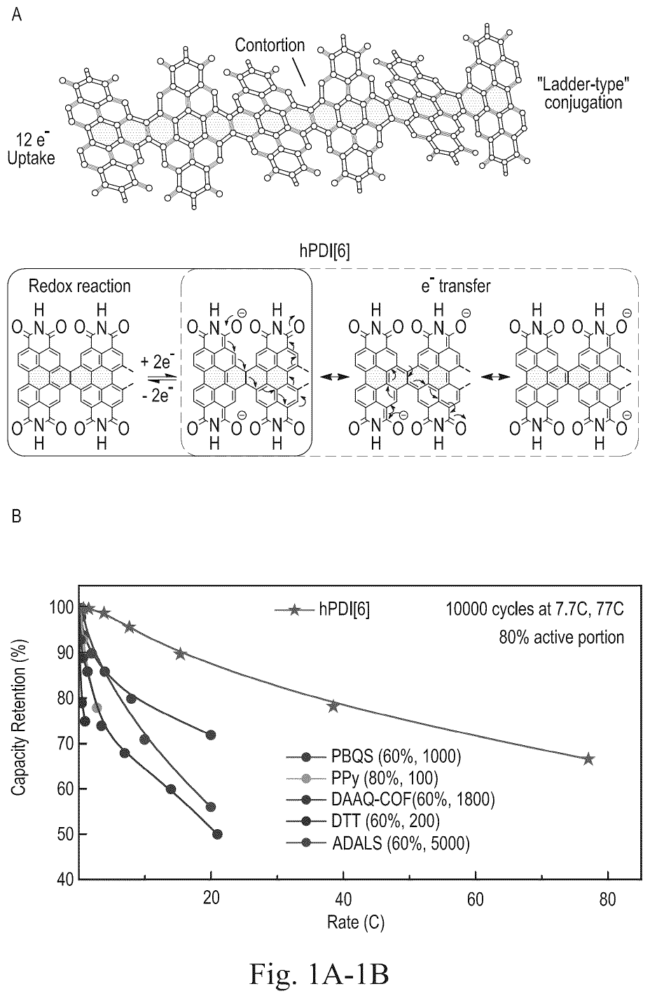

In certain embodiments, a molecular design of a fully conjugated “ladder-type” macromolecule is provided. In certain aspects, an efficacious member of the series is the contorted helical perylene diimide[n](thereafter in, as hPDI[n]) macromolecule, where n redox-active PDI subunits can be fused together by ethylene subunits, as shown in FIG. 1A. As structured in FIG. 1A, the contortion dimension, e.g., direction and angle, can be modulated and coordinated depending on what design is on demand.

In an embodiment of the disclosed subject matter, this contorted, ladder-type conjugated, atomically precise macromolecule can be designed under four principles for organic electrodes to achieve exceptional rate capability and cycling stability: (1) the redox-active PDI subunits can feature high stability and fast redox kinetics; (2) the solubility of these macromolecules can be controlled, which can allow the designed material to resolve the dissolution issue from small molecules while exhibiting the efficient conjugation of polymeric structures; (3) the contortion of adjacent PDIs can facilitate lithium-ion transport in the solid material and can increase the ionic conductivity; (4) the defined fully conjugated ladder structure can provide high electrical conductivity. In certain embodiments of the disclosed matter, the contorted helical perylene diimide macromolecule includes hPDI[6].

Regarding the calculation of molecular structure, Jaguar (version 8.2, Schrodinger, Inc., New York, NY, 2013) was used to perform all the quantum chemical calculations.25 All geometries were optimized using the B3LYP functional and the 6-31 G basis set. In model compounds, the alkyl chain groups were replaced by hydrogens. The waggling conformation was calculated due to their stability in solid state.

[hPDI[6] Battery Performance of the Molecular]

As embodied herein, electrical performance with different OBEMs has been measured via a rate-capacity retention experiment. The results are shown in FIG. 1B, where the active portion refers to the portion of the battery's capacity that remains usable after cycling the battery at a particular rate, and the cycles number refers to the repeated times of the process. Notably, the active portion is the percentage of the battery's initial capacity that remains usable after cycling the battery at a particular rate, and the remaining portion of the capacity which is not usable represents the battery's degradation over time. Controlled battery samples were tested with various organic battery electrode materials (OBEMs) including PBQS, PPy, DAAQ-COF, DTT, and ADALS. These samples were charged for cycling times less than 5000 and displayed a capacity retention curve that exhibited a steep drop at rates lower than 20 C. In contrast, the hPDI[6] battery sample was charged for up to 10000 cycles at a rate of 77 C and exhibited an active portion of 80%. The Rate-Capacity retention curve for the hPDI[6] sample displayed a gradually smooth line with increasing rate, which indicates superior battery performance and an effective lifespan in Lithium-ion battery applications compared to other OBEMs tested.

### III. Synthesis

Compared to certain synthetic methods used to synthesize hPDI[n](up to n=4) which did not allow for the synthesis of longer ribbons due to the incomplete photocyclization, a reliable and effective synthesis for hPDI[n] is provided herein. To resolve the issue, the electrical conductivity and ionic conductivity can be engineered and improved by increasing both the length of π-conjugation and the number of contorted aromatic sites. Atomically defined, ladder-type fully conjugated structures were formed that were relatively long.

As embodied herein, hPDI[n]-C₁₁ as a perylene diimide derivatives, is intermediate product during the synthesis. It is a type of organic semiconductor material that is can be used in the development of organic electronic devices, such as organic photovoltaic cells, organic light-emitting diodes, and organic field-effect transistors. For example, the hPDI[2]-C₁₁ molecule consists of two perylene diimide units that are connected by a flexible linker containing 11 carbon atoms (C₁₁). The molecule has a planar, rigid structure that enables it to form highly ordered thin films when deposited onto a substrate. The C₁₁ linker can provide flexibility to the molecule, which can help to improve its solubility and processability during the synthesis.

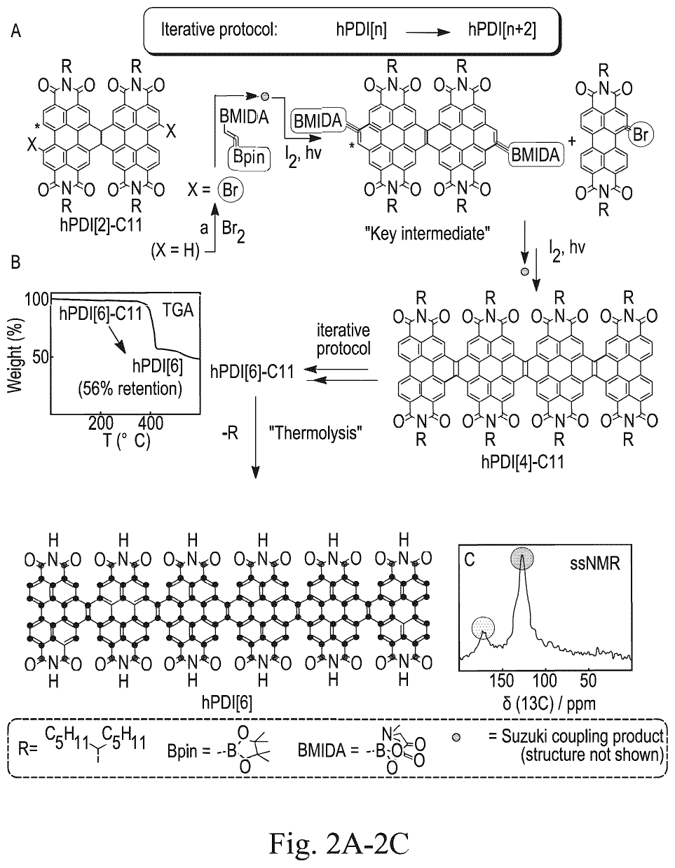

In certain embodiments, an iterative synthetic protocol was performed involving two repetitive “Suzuki reaction-Mallory photocyclization” sequences that provided a quantitative photocyclization, as shown in FIG. 2A (asterisks indicate the position of corresponding groups from the Regio isomers). In the embodiment, the iterative synthesis of hPDI[n]-C₁₁ or hPDI [n] can be implemented as follows:

1) The hPDI is brominated to DiBr-hPDI; 2) Suzuki reaction is implemented between DiBr-hPDI and BMIDA; 3) pre-hPDI[n+2] is synthesized; 4) hPDI[n+2]-C₁₁ is synthesized; 5) hPDI[n] is synthesized during thermolysis. This process can be varied flexibly, e.g., via alternative process order of reactions, as would be appreciated by a person of skill in the art. In addition, the skilled artisan would appreciate and understand that process parameters, e.g., reagent volume/concentration, temperature, and pressure, are readily determined for implementing the synthesis.

As embodied herein, from the synthesis protocol, hPDI[6]-C₁₁ can be prepared from the shorter hPDI[2]-C₁₁. Vacuum thermolysis was performed on hPDI[6]-C₁₁ at 300-400° C. to quantitatively remove the alkyl chains (see the thermogravimetric analysis, as shown in the bottom of FIG. 2A), which improved the gravimetrical capacity by reducing the electro-inactive mass and simultaneously rendered the material insoluble. The structure of hPDI[6] was confirmed by solid-state ¹³C NMR ((Nuclear Magnetic Resonance), infrared spectroscopy, and MALDI (Matrix-Assisted LaserDesorption/Ionization) mass spectrometry. As shown in FIG. 2C, a generation of hPDI[6] was determined by solid state ¹³C NMR.

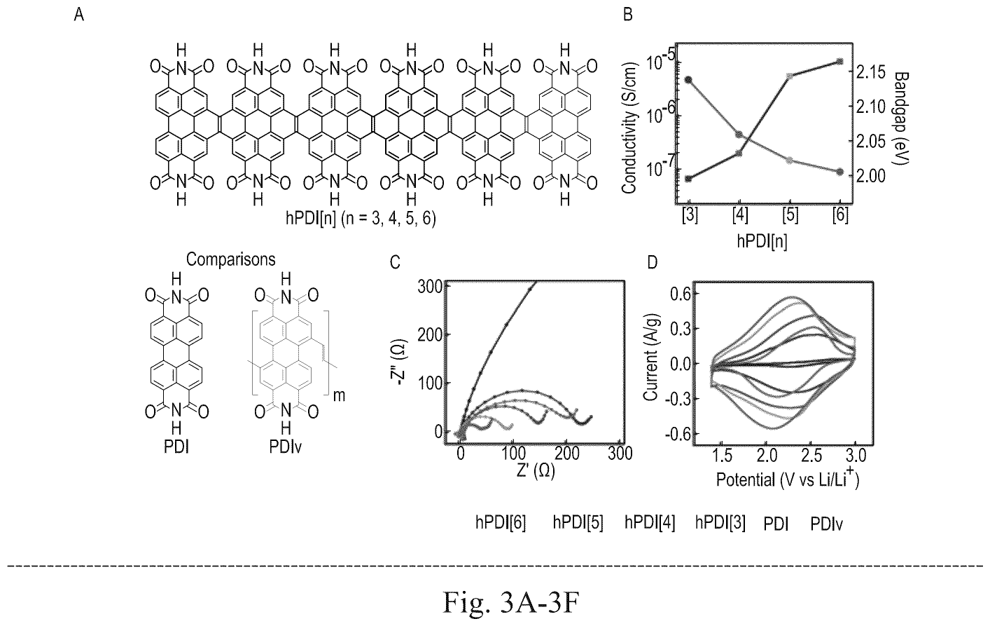

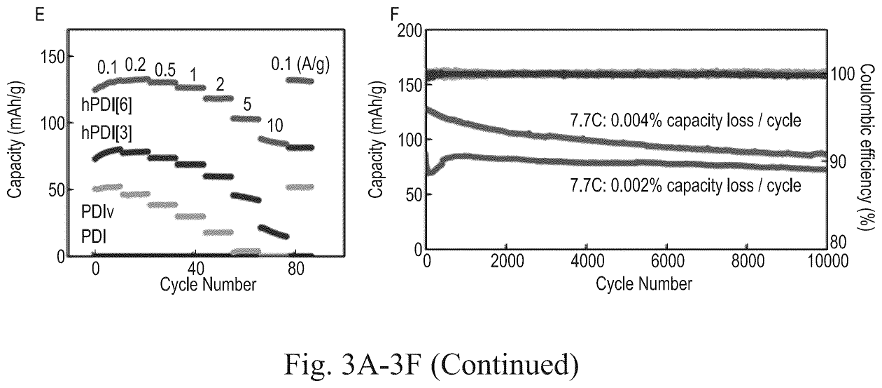

In some embodiments, as shown in FIG. 3A, shorter hPDI[n] (n=3,4,5) ribbons were prepared under the same protocol and the electrical conductivity of the hPDI[n] (n=3, 4, 5, 6) thin films were measured by a two-probe method. As shown in FIG. 3B, the electrical conductivity of hPDI[5] and hPDI[6] can be one order of magnitude higher than those of shorter ribbons. Thus, it was demonstrated that the electrical conductivity of the hPDI[n] family increased substantially as the ribbons were extended. The HOMO-LUMO gap of hPDI[n] ribbons was estimated from absorption maxima of their hPDI[n]-C₁₁ counterpart. The bandgap of infinite hPDI[n] polymers was estimated to be 1.96 eV. Thus, hPDI[6](with a bandgap of 2.00 eV) can be a good proxy for the polymeric hPDI[n] structures. Therefore, the improvement of electrical conductivity can originate from the lengthy conjugated structure of hPDI[n]. These conductivities can be from the undoped molecules, and the materials can have a relatively higher conductivity when reduced to their anionic forms. Taken together, increasing the length of the conjugated ribbons can be an effective method to improve the electrical conductivity.

### EXAMPLES

### Example 1: Synthesis of hPDI[6]

### 1. Synthesis Overview

Materials. All chemicals were obtained from commercial sources and used as received unless otherwise noted. Flash chromatography (FC) was carried out with Silica 60 (230-400 mesh; Fisher). Analytical thin-layer chromatography (TLC) was carried out using 0.2 mm silica gel plate (silica gel 60, F254, EMD Chemical).

MALDI-TOF. The mass spectroscopic data were obtained at the Columbia University mass spectrometry facility using a Bruker ultrafleXtreme MALDI TOF/TOF with a frequency-tripled Nd:YAG laser (355 nm).

Solution state NMR. Solution state ¹H and ¹³C NMR spectra were recorded on a Bruker 400 MHz, 500 MHz spectrometer. Chemical shifts for protons are reported in parts per million downfield from tetramethyl silane and are referenced to residual protium within the NMR solvent (CHCl₃: δ 7.26). Chemical shifts for carbon are reported in parts per million downfield from tetramethyl silane and are referenced to the carbon resonances of the solvent (CDCl₃: δ77.0). Data are represented as follows: chemical shift, multiplicity, (s=singlet, d=doublet, t=triplet, m=multiplet, b=broad, bm=broad multiplet), coupling constants in hertz, and integration.

Solid State NMR (SSNMR). The SSNMR experiments were performed on a 600 MHz magnet equipped with Bruker NEO console using a 1.6 mm HFXY probe. All the experiments were taken at ambient temperature with magic-angle-spinning rate at 20 kHz. ¹H-¹³C cross polarization was used to take carbon spectrum with 100 kHz decoupling during signal acquisition. ¹H proton spectra were taken with a 90-echo pulse sequence to achieve a reasonable baseline. All the carbon spectra were processed using an exponential window function with 200 Hz broadening. No apodization function was used for proton spectrum. ¹³C Chemical shifts were referenced to the downfield carbon chemical shift of adamantane at 40.48 ppm, and ¹H chemical shifts were referenced to solution DSS.

Electronic Absorption (UV-vis). Absorption spectra were obtained on a Shimadzu UV 1800 UV/vis spectrophotometer.

Powder X-Ray Diffraction (PXRD). The PXRD were measured on a PANalytical XPert3 Powder X-ray diffractometer, on a rotating Si zero-background plate.

### 2. Synthetic Procedures

2.1 Iterative synthesis of hPDI[n]-C₁₁

Bromination of hPDI is implemented as the following chemical equation (1):

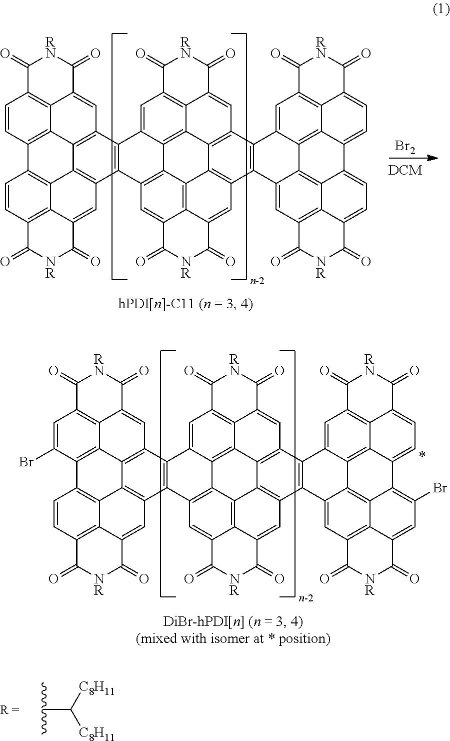

Procedure 1: hPDI[n] was dissolved in 5 mL of dichloromethane in a 20 ml vial with a stir bar. Excess bromine (400 equiv.) was added, followed by few crystals of iodine. The solution was capped and stirred at room temperature. The reaction was monitored by TLC until only one spot presented. Bromine was then quenched with saturated solution of sodium bisulfite and extracted with dichloromethane. The combined organic layer was dried over anhydrous magnesium sulfate and concentrated under reduced pressure. The solid was washed with MeOH, collected by filtration, and washed with cold MeOH to obtain the corresponding hPDI[n]-diBr.

DiBr-hPDI[3]: hPDI[3](500 mg, 0.23 mmol) was converted to DiBr-hPDI[3] as a dark red solid (530 mg, 99% yield) according to procedure 1.

DiBr-hPDI[4]: hPDI[4](400 mg, 0.14 mmol) was converted to DiBr-hPDI[4](422 mg, 99% yield) as a dark red solid quantitatively according to the procedure 1.

Suzuki reaction of DiBr-hPDI is implemented as the following chemical equation (2):

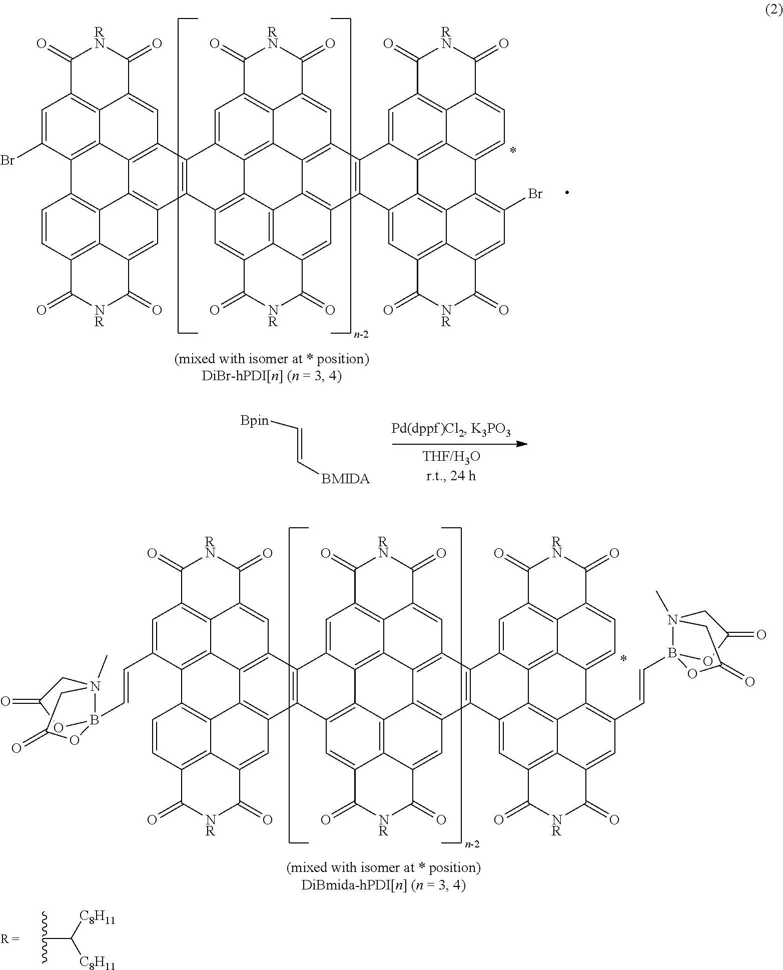

Procedure 2: To a Schlenk flask were added DiBr-hPDI[n], trans-2-(pinacol boronate)vinylboronic acid MTDA ester (2.5 equiv.), anhydrous potassium phosphate (12 equiv.), and Pd(dppf)Cl₂ (0.15 equiv.). The Schlenk flask was sealed with a rubber septum and the headspace was evacuated and backfilled with nitrogen three times, to which was then added nitrogen-sparged THE (8 mM) and water (20 equiv.). The reaction mixture was stirred at ambient temperature for 24 hours, and concentrated in vacuo. The residue was re-dissolved in DCM, loaded onto a silica plug, and washed with dichloromethane/ethyl acetate (7:3) to remove unreacted starting materials, mono-coupling products and other byproducts. Then the product was flushed out with tetrahydrofuran and concentrated in vacuo. The solid was washed with acetonitrile to remove unreacted trans-2-(pinacol boronate)vinylboronic acid MIDA ester, collected by filtration, and washed with acetonitrile to obtain the product.

DiBmida-hPDI[3]: the product was obtained as a dark red solid (181 mg, 83%) according to the procedure 2.

DiBmida-hPDI[4]: the product was obtained as a dark black solid (91 mg, 85%) according to the procedure 2.

pre-hPDI[n+2] synthesis was implemented as the following chemical equation (3):

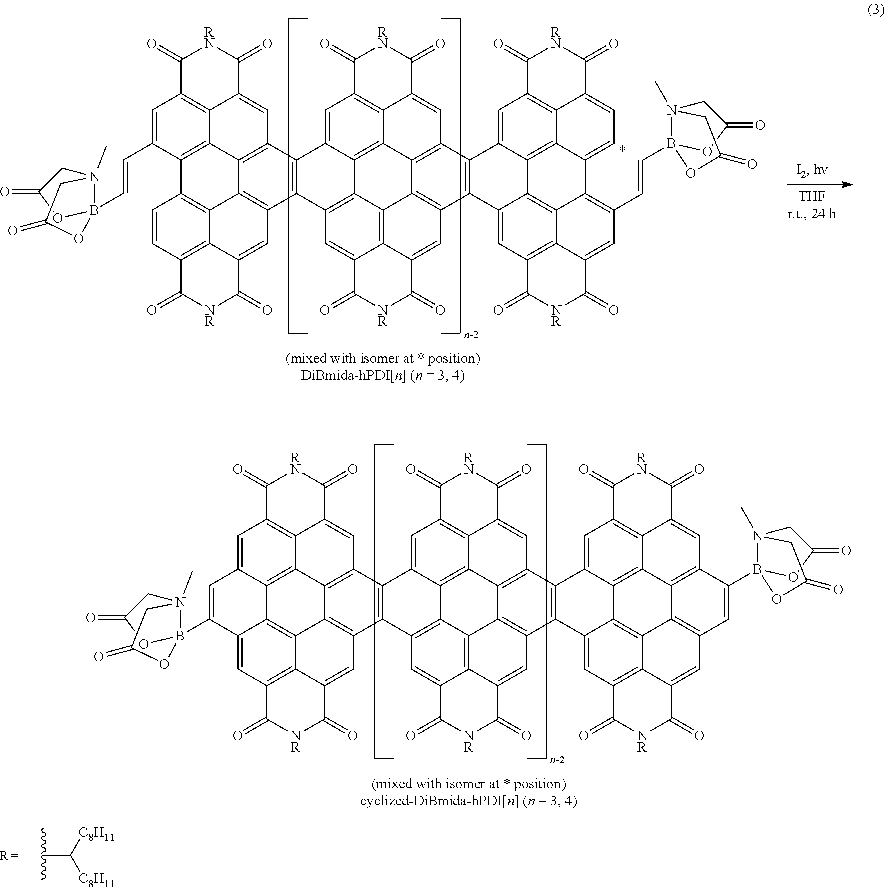

Procedure 3: DiMDA-hPDI, iodine (2 equiv.) and TH) (10⁻³ mM) were added to an Erlenmeyer flask. The flask was irradiated by four 150 W white LED lights for 24 hours. The solvent was removed in vacuo, and the residue was re-dissolved in DCM, loaded onto a silica plug, and washed with dichloromethane/ethyl acetate (7:3) to remove by-products. Then the product was flushed out with tetrahydrofuran and concentrated in vacuo, which was subjected to the following without further purification.

cyclized-DiBmida-hPDI[3]: the product was obtained as a dark solid (100 mg, 57%) according to procedure 3.

cyclized-DiBmida-hPDI[4]: the product was obtained as a dark solid (46 mg, 510) according to procedure 3.

pre-PDI[2][n=5,6] synthesis was implemented as the following chemical equation (4):

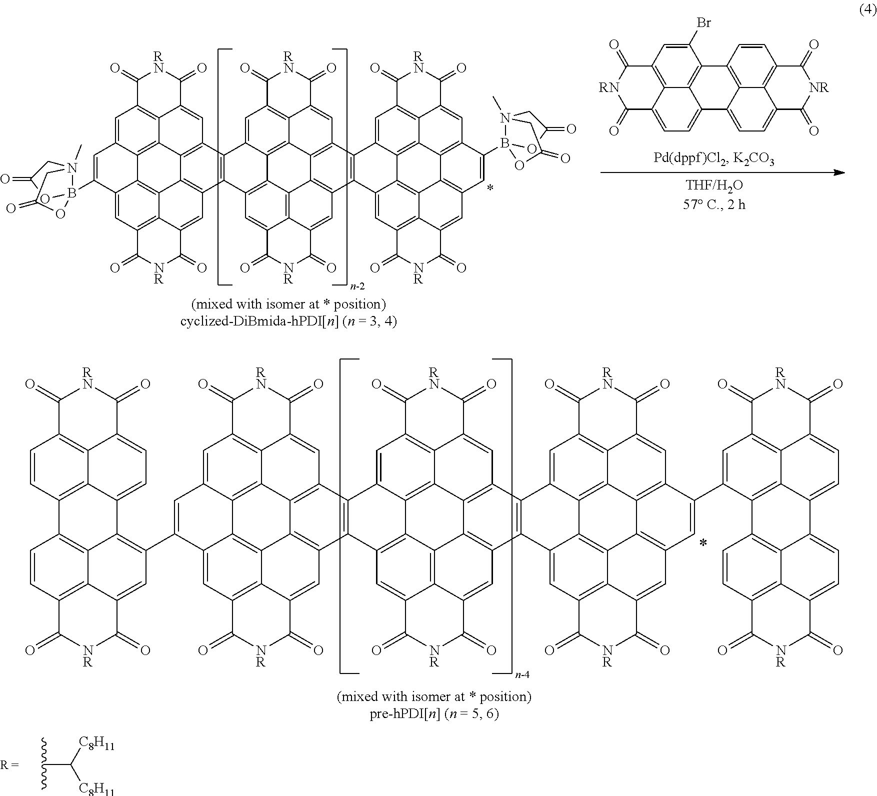

Procedure 4: To a vial was added cyclized-DiBlmida-hPDI, 1-bromoperylene-3,4,9,10-tetracarboxylicdiimide (PDI-Br, 2.2 equiv.), Pd(dppf)Cl₂ (0.1 equiv.), and potassium carbonate (12 equiv.). The headspace of the vial was evacuated under vacuum and backfilled with nitrogen three times. Air-free TTIW/H2O (v/v, 4:1, 2 mM) solution was then added to the reaction vessel via syringe under nitrogen gas flow, which was sealed with a Teflon cap. The dark-red solution was stirred at 57° C. for 12 hours, and concentrated in vacuo. The residue was purified via column chromatography (DCM:hexanes, 5:1) to afford pre-hPDI.

pre-hPDI[5]: the product was obtained as a dark red solid (110 mg, 74%) according to procedure 4.

pre-hPDI[6]: the product was obtained as a dark black solid (34 mg, 55%) according to procedure 4.

hPDI[n+2]-C₁₁ synthesis was implemented as the following chemical equation (5):

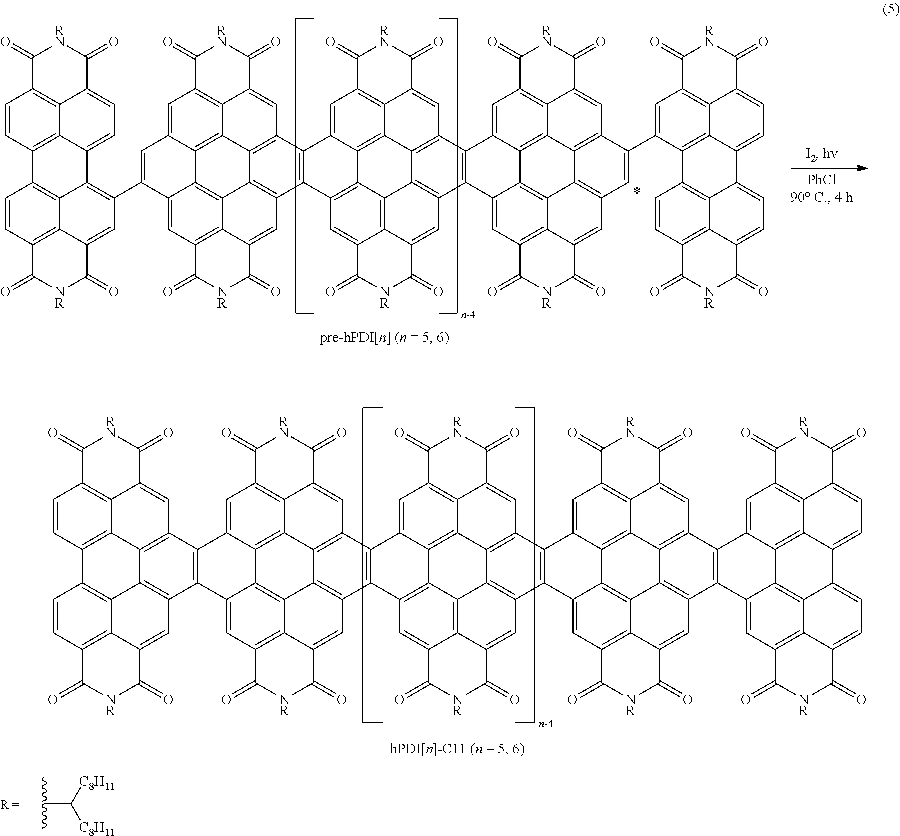

Procedure 5: The pre-hPDI was dissolved in chlorobenzene (0.1 mM) and added to a 100 mL threaded culture tube. The solution was added iodine (4 equiv.). The tube was sealed and placed into a pristine oil bath heated at 90° C., which was irradiated by four 150 W white LED lights for 4 hours. The reaction mixture was concentrated in vacuo, and the residue was purified via methanol wash to afford hPDI.

hPDI[5]-C₁₁: the product was obtained as a dark red solid (110 mg, 99% yield) according to procedure 5.

hPDI[6]-C₁₁: the product was obtained as a dark black solid (33 mg, 99% yield) according to procedure 5.

hPDI[4]-Cu was synthesized via the described protocol from hPDI[2]-C₁₁ in 40% total yield and the ¹H NMR spectrum matches well with the measurement.

2.2 Synthesis of hPDI[n] was implemented as the following equation (6):

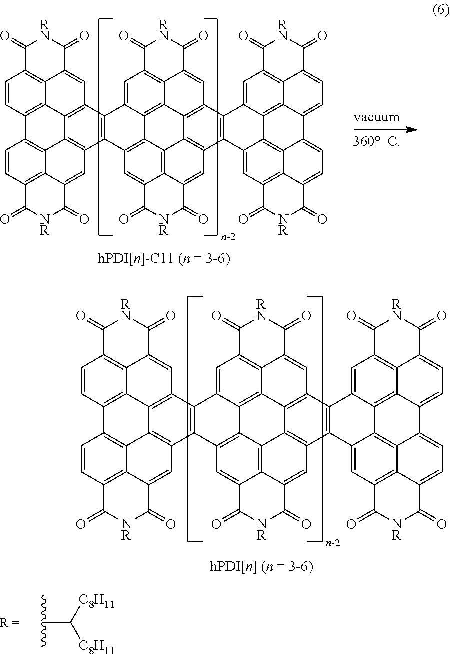

Procedure 6: A 4 ml vial charged with hPDI[n]-C₁₁ was placed in a borosilicate glass tube. The tube was then transferred to a tube furnace. The end with the solid was placed in the middle of the furnace and the other end was out of the furnace. The furnace was heated to T=360° C. under vacuum for 2 hours. After cooling to room temperature, hPDI[n] was collected.

hPDI[3]: the product was obtained as a dark red solid (quant. yield) according to procedure 6, which was detected and determined by NMR.

hPDI[4]: the product was obtained as a dark red solid (quant. yield) according to procedure 6, which was detected and determined by NMR.

hPDI[5]: the product was obtained as a dark red solid (quant. yield) according to procedure 6, which was detected and determined by NMR.

hPDI[6]: the product was obtained as a dark red solid (quant. yield) according to procedure 6, which was detected and determined by NMR.

### 2.3 Synthesis of PDIv

To a vial was added a mixture of 1,6- and 1,7-dibromoperylene-3,4,9,10-tetracarboxylicdiimide (200 mg, 0.23 mmol), trans-2-(pinacol boronate)vinylboronic acid MIDA ester (72 mg, 0.23 mmol), Pd(dppf)Cl₂ (17 mg, 0.023 mmol), and potassium carbonate (385 mg, 2.8 mmol). The headspace of the vial was evacuated under vacuum and backfilled with nitrogen three times. Air-free THF/H2O (v/v, 4:1, 2 mM) solution was then added to the reaction vessel via syringe under nitrogen gas flow, which was sealed with a Teflon cap. The solution was stirred at 57° C. for 12 hours, and concentrated in vacuo. The mixture was triturated with methanol, and the solid was collected. The solid was subjected to consecutive Soxhlet extractions comprised of methanol, hexanes, and chloroform. The chloroform fraction was collected and dried to yield PDIv as a dark purple solid, which was detected and determined by NMR.

### Example 2: Electrodes And Electrochemical Performance

### [Electrode Fabrication.]

The active materials were mixed with Super P carbon (C65, Imerys Graphite & Carbon), and poly(vinylidene fluoride) (PVDF) (Kynar Flex) in an 8:1:1 ratio, and grounded in an agate mortar for half an hour. Then N-methyl-2-pyrrolidone (NMP) was added to the mixture and the slurry was sonicated for 2 h. After all materials were fully mixed, the slurry was drop-casted onto a carbon paper current collector (Fuel Cell Store). The coated electrodes were dried for 2 h at 60° C., and then dried in a vacuum oven at 110° C. overnight. The average active material loading was ˜1 mg/cm for the performance tests and pouch cell fabrication and 5 mg/cm for high areal mass loading tests.

### [Coin Cell Assembly.]

In an argon-filled glovebox with both water and oxygen level <0.1 ppm, the CR 2032 coin cells were assembled using lithium metal disks as anode, thin polyethylene separator (10 m), ˜100 μL 1M LiPF6 in ethylene carbonate (EC)/diethyl carbonate (DEC) (1:1 vol) electrolyte (LP40) and the fabricated cathode.

### [Pouch Cell Assembly.]

In an argon-filled glovebox with both water and oxygen level <0.1 ppm, the square cathode (4×5 cm) and lithium metal foil anode (4×5 cm) were separated with a thin polyethylene separator and wetted with 750 μl of LP40 electrolyte. The stack was placed inside a plastic pouch (˜6×7 cm), contacted with aluminum tab for cathode and nickel tab for anode as the current collectors (thickness ˜0.13 mm) and sealed under vacuum using a vacuum heat sealer. The cell was clamped in a vice with flat blocks on either side to ensure good contact between all components, under a pressure of ˜100 pounds per square inch.

### [Electrochemical Measurements.]

All CV tests and EIS were conducted with a VMP3 multichannel potentiostat from Bio-Logic. For the EIS tests, the assembled coin cells were rested for 12 hours and then cycled for three times, and stopped at the voltage of 2.3 V, which is near its redox potential, then the cells were ready for electrochemical tests. The cycling tests were performed using Landt battery testers. Electrochemical impedance spectroscopy (EIS): The amplitude for EIS is 10 mV and the frequency range is from 0.1 Hz to 1 MHz. Around 6 frequencies were taken in each decade and with a total measurement time of around 1 minute.

### [Diffusion Coefficient Analysis.]

Cyclic voltammetry was performed on the assembled coin cells at scan rates between 1 mV s⁻¹ to 25 mV s⁻¹. The peak current (iₚ) from the oxidation peak of each scan was plotted versus the square root of scan rate (ν).

To evaluate the electrochemical performance of hPDI[n], the hPDI[n] electrodes were prepared by drop casting a slurry of 80 wt. % hPDI[n], 10 wt. % carbon black (as conductive agent) and 10 wt. % polyvinylidene fluoride (PVDF; as binder) in N-methyl-2-pyrrolidone onto a carbon paper. Such a high portion of active material can be readily used for tests of inorganic materials but can be higher than those readily tested in organic materials. The electrodes were assembled with lithium metal and 1M LiPF6 in diethyl carbonate (DEC)/ethylene carbonate (EC) (1:1 by volume) electrolyte in 2032 Coin cells. For comparison, the PDI monomer and a PDI-vinyl conjugated polymer (PDIv) with similar theoretical gravimetric capacity was tested. As illustrated in FIG. 3C, the electrochemical impedance spectroscopy (EIS) of these cells provides that the charge-transfer resistances (Rct) for hPDI[n] can decrease as the ribbon is made longer, PDI exhibits a relatively high Rct of 1500Ω and PDIv can exhibit similar Rct as hPDI[3]. There is a correlation of Rct with the electrical conductivity of the pristine materials. The relatively low charge transfer resistance of hPDI[6](47Ω) can facilitate fast electron transport, which can from fast intramolecular and intermolecular charge transfer.

Cyclic voltammograms (CV) were performed to examine the electrochemical behaviors of (h)PDI[n] (n=1, 3, 4, 5, 6) and PDIv (FIG. 3D). As illustrated in FIG. 3D, at a scan rate of 1 mV/s, hPDI[n] displayed a broad and reversible redox couple at a potential of 2.2 V vs Li/Li+, matching the redox events of PDI subunits. The peak current of hPDI[n] increased as the ribbon length increased, which provides the improved electrochemical performance as [n] increased. Analysis on the log-log plot of the sweep rate (v) versus the peak current (i) showed that hPDI[n] ribbons exhibited surface-controlled kinetics, PDI exhibited diffusion-controlled behavior and PDIv was in-between. Thus, the molecular contortion sites can facilitate lithium-ion transport in hPDI[n]. The lithium-ion diffusion rates using the Randles-Ševčik equation were used to demonstrate the contortion effect on lithium-ion transport. The measurement results are shown in the below Table 1.

TABLE 1

| | Electrical | | | | |
|---|---|---|---|---|---|
| | conductivity | D_{Li}⁺ | Rct | C_{spec@0.77 C} | C_{spec@77 C}/ |
| Compound | [S/cm] | [cm²/s] | [Ω] | [mAh/g] | Cₜₕₑₒ |
| PDI | 1.1 × 10⁻¹⁰ | 1.1 × 10^{-13 a} | 1396 | 3.2 | — |
| hPDI[3] | 6.7 × 10⁻⁸ | 1.8 × 10^{-11 b} | 225 | 79 | 28% |
| hPDI[4] | 2.0 × 10⁻⁷ | 3.4 × 10^{-11 b} | 150 | 101 | 49% |
| hPDI[5] | 5.5 × 10⁻⁶ | 3.5 × 10^{-10 b} | 95 | 114 | 64% |
| hPDI[6] | 1.0 × 10⁻⁵ | 5.7 × 10^{-10 b} | 47 | 130 | 67% |
| PDIv | 4.8 × 10⁻⁸ | 1.9 × 10^{-11 b} | 198 | 51 | — |

C_{spec}: specific capacity.
Cₜₕₑₒ: theoretical capacity.
^{a} Obtained from CV.
^{b} Obtained from EIS

For hPDI[n] series, the D_{Li}⁺ (Diffusion Coefficient of Li+ ions, cm²/s) increased as the length of the macromolecule increased from hPDI[3](1.8×10⁻¹¹ cm²/s) to hPDI[6](5.7×10⁻¹⁰ cm²/s). The PDIv conjugated polymer, however, exhibited a lower ionic conductivity of 1.9×10⁻¹¹ cm²/s. Thus, the lower ionic conductivity in the shorter oligomers and the PDIv polymer can be due to the lacking/absence of well-defined position of the carbonyls imposed by molecular contortion in the longer oligomers. This was verified by EIS and galvanostatic intermittent titration technique (GITT). The high ionic conductivity of hPDI[6] can result from the contorted imides in the long oligomers acting as a conveyer belt for lithium ions.

With improved electrical and ionic conductivity, hPDI[6] can achieve exceptional power density and best-in-class cycling stability as a cathode material. FIG. 3E displays the increasing rate capability of PDI, PDIv, hPDI[3] and hPDI[6] at different discharge rates from 0.1 A/g to 10 A/g. At 0.1 A/g (0.77 C), hPDI[6] reached 99% of the theoretical specific capacity value. hPDI[6] exhibited almost no loss in capacity until the rate of the current was increased to 2 A/g. Even at a 100-fold current rate of 10 A/g (77 C), hPDI[6] had a specific capacity of 87 mAh/g. Thus, hPDI[6] batteries can be charged to 67% of its capacity within 35 seconds, corresponding to a specific power density of 22,000 W/kg. This high-rate performance of hPDI[6] can be both high ionic conductivity from the molecular contortion and electrical conductivity from precisely defined, “ladder-type” conjugated structures. hPDI[6] cathode can exhibit high cycling stability, as shown in FIG. 3F. At 1 A/g, hPDI[6] had an initial capacity of 126 mAh/g and preserve 86 mAh/g after 10,000 cycles at 7.7 C, corresponding to capacity fade of only 0.004% each cycle. At a higher rate (10 A/g, 77 C), hPDI[6] cathode also maintained its stability, with 84% capacity retention over 10,000 cycles, corresponding to an ultra-low capacity 0.0017% loss per cycle. Collectively, the hPDI[6] can be a fast-charging cathode, which can be due to its high-power density and cycling stability.

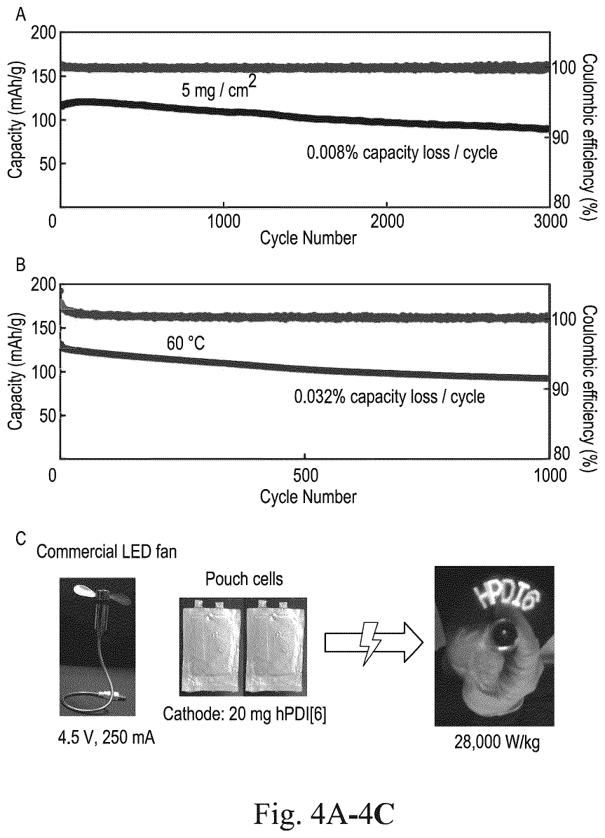

Besides the high-rate performance and cycling lifetime, hPDI[6] cathodes can maintain their high performance in both high mass loading and high temperature conditions. To date, most lithium-ion batteries using organic materials as electrodes can be limited to a low mass loading of around 0.1-1 mg/cm² due to intrinsically low electrical conductivity of the materials. In this embodiment, the electrodes with active material loading of 5 mg/cm² were fabricated to test the high mass loading ability of hPDI[6]. As shown in FIG. 4A, the cells with high mass-loading hPDI[6] maintained 96% of theoretical specific capacity (121 mAh/g) at 1 A/g, with high cycling stability of 75% capacity retention after 3,000 cycles. Furthermore, hPDI[6] cathodes also exhibited reliable high temperature performance with an initial capacity of 131 mAh/g and 71% capacity retention after 1000 cycles at 60° C., as shown in FIG. 4B.

### Example 3: Practical Application of hPDI[6] Battery

As embodied herein, pouch cells to power a commercial LED fan were fabricated, for example, to provide the practical relevance of hPDI[6] materials. The working voltage and current of the fan were 4-5 V and 200-300 mA, respectively, corresponding to a total power ˜1.12 W. Pouch cells (4 cm×5 cm) were built with a cathode composite containing 20 mg of hPDI[6]. Two pouch cells were used to provide enough voltage. As shown in FIG. 4C, the battery powered the LED fan for 40 seconds, corresponding to a power density of 28,000 W/kg. Such power density is 50-fold beyond current state-of-the-art LIBs.

At least from the examples, a contorted, atomically defined hPDI[6] macromolecular ladder with high ionic and electrical conductivity as a fast-charging and long-lifetime battery cathode is provided. hPDI[n] was efficiently synthesized via a newly developed iterative protocol. The electrical conductivity of hPDI[n] can be engineered and improved by increasing the conjugation of the ribbons. In addition, longer hPDI[n] ribbons introduced more contortion sites and accelerated the ion transport. With improved electrical conductivity and ion diffusion rate, hPDI[6] cathodes had a power density two magnitudes higher than the conventional inorganic materials. Batteries with hPDI[6] as a cathode can be charged to 67% of its maximum capacity within 35 seconds. The stable structure of hPDI[6] allowed it to cycle 10,000 times without any appreciable capacity decay. Moreover, hPDI[6] was also compatible with existing manufacturing due to its high mass loading and the low ratio of conductive additive, meaning it can be used for batteries without further modification. Thus, both the conjugation and contortion can improve rate performance of organic materials. A streamlined chemical model for fast charging, long lifetime, and sustainable battery electrodes can be provided, accordingly.

What we claim is:

1. A molecular array of contorted and conjugated macromolecular ladders, comprising:
one or more macromolecular ladders contorted and conjugated at one or more aromatic sites.

2. The molecular array of claim 1, wherein the macromolecule is configured to have at least a ladder-type conjugated structure and comprise a plurality of hPDI[n] oligomers, wherein n is an integer from 1 to 6.

3. The molecular array of claim 1, wherein the macromolecular ladder comprises a hPDI[6] oligomer.

4. A method for synthesizing a molecular array of contorted and conjugated macromolecular ladders, comprising:
(a) preparing a precursor comprising a plurality of hPDI[n], wherein n is an integer from 1 to 6;
(b) polymerizing the precursor by a repetitive Suzuki-Mallory polymerization process to form a contorted and conjugated macromolecular ladder having a ladder-type conjugated structure and comprising the hPDI[n].

5. The method of claim 4, wherein the hPDI[n] oligomer is hPDI[6].

6. The method of claim 4, wherein the PDI subunit is selectively fused by ethylene subunits.

7. The method of claim 4, wherein the polymerization process comprises a modeling on conjugation length and contortion of the macromolecular ladders.

8. The method of claim 4, wherein the hPDI[n] is prepared from hPDI[n]-C₁₁.

9. The method of claim 4, wherein the hPDI[n] is ribbon-structure conjugated and contorted.

10. An electrode for use in a lithium-ion battery, comprising a molecular array of claim 1.

11. The electrode of claim 10, wherein the molecular is formulated as a cathode.

12. A lithium-ion battery, comprising a lithium-ion electrode of claim 11.
